(19) United States
(12) Patent Application Publication
(10) Pub. No.: US 2011/0110838 A1
(43) Pub. Date: May 12, 2011

(54) METHOD OF SOLID-LIQUID MIXING GEL PROCESS FOR LiFePO4 SYNTHESIS

(75) Inventors: Ning Wang, Martinez, CA (US); Shifan Cheng, Dublin, CA (US)

(73) Assignee: INTEMATIX CORPORATION, Fremont, CA (US)

(21) Appl. No.: 12/832,743

(22) Filed: Jul. 8, 2010

Related U.S. Application Data
(60) Provisional application No. 61/224,796, filed on Jul. 10, 2009.

(51) Int. Cl. C01B 25/45

(52) U.S. Cl. 423/306

(57) ABSTRACT

A method of synthesizing LiFePO₄ compounds and analogs thereof for use in secondary electrodes involves mixing the starting materials and polymerizing the mixture into a gel. The gel form allows thorough milling and mixing of the reagents and results in a smaller and more uniform particle size in the resultant electrode formed and a well crystallized structure based on the X-ray diffraction pattern.

### CLAIM OF PRIORITY

This application claims priority to U.S. Provisional Patent Application No. 61/224,796 entitled “METHOD OF SOLID-LIQUID MIXING GEL PROCESS FOR LiFePO₄ SYNTHESIS” by Inventors Ning Wang and Shifan Cheng, filed Jul. 10, 2009, the contents of which are incorporated herein by reference.

### FIELD OF THE INVENTION

The present invention relates to a processing method for cathode material of the secondary (rechargeable) lithium battery. More specifically, the invention relates to a processing method for LiFePO₄ and similar secondary battery electrode materials. The invention provides a gel processing method or polymerization method for mixing the solid reactants and liquid reactants. Finally, the reactants are evenly distributed in the 3-dimension gel structure.

### BACKGROUND OF THE INVENTION

Portable electronic devices, such as notebook computers, mobile phones, and the like, become more and more popular. At the same time portable devices, such as electric tools, require more powerful energy sources. Currently, a clean energy source has become more and more significant for a battery powered vehicle application. Secondary (rechargeable) batteries play a very important role for all of the above applications. Cobalt-based lithium batteries have been extensively used for over 10 years. The low thermal stability of cobalt-based lithium battery is a critical factor to constrain its further application, especially for high power application. John Goodenough et al. invented a new lithium compound, LiFePO₄ for use as a cathode material, which is much more stable than cobalt-based lithium compounds (U.S. Pat. No. 5,910,382).

LiFePO₄ may be synthesized by different routes. The related methods may be divided into two main groups: solid processes (including processes involving a slurry with solid powders) and liquid processes. A typical solid process is represented by a published patent application of A123 Systems (see U.S. 2007/0190418). The raw materials required for the synthesis are Li₂CO₃, iron oxalate and ammonium phosphate. These powders are fully milled, then fired at 700° C. for 5 h. The specific surface is 45.4 m²/g, corresponding to an equivalent spherical particle diameter of 37.7 nm. This nano powder shows an outstanding capacity at higher C-rate. At a 5C rate, the capacity retention was 95%, at a 10C rate, the capacity retention was about 90%. A carbon thermal reaction was combined with the powder processing method (see U.S. Pat. Nos. 6,528,033; 6,716,372; 7,060,206; and 7,348,100). The available raw materials include carbon and FePO₄, Fe₂O₃, Li₂CO₃ (NH₄)₂HPO₄. etc. Other than elemental carbon, different organic compounds are also used as reducing agents and to increase conductivity (U.S. Pat. No. 7,285,260).

U.S. Pat. No. 7,338,647 proposes a slurry process method for generating electrode materials. The slurry comprises a polymeric material, a solvent, a polyanion source or alkali metal polyanion source and at least one metal ion source. The slurry is heated for a time sufficient to remove the solvent and form a dried mixture. The mixture is heated to form the electrode material.

The liquid process category includes a number of different solution processes. Published Chinese patent CN 1773754 discloses a liquid process method. The soluble iron salt, LiH₂PO₄ and other metal salts are used to make a solution. The solution is spray-dried at a temperature between 300-500° C. In the chamber, LiFePO₄ particles are nucleated and grow up. Published Chinese patent CN 1803590 discloses a method using a solution of soluble metal salts and a phosphorous chelate compound. Published Chinese patent CN 1564347 discloses a liquid-gel processing method. The solution comprises a soluble lithium salt, a source of phosphate and metal nitrates. The organic gel comprises citric acid, polyethylene glycol and glucose. An ultrasonic spray pyrolysis has also been used with nitrate, phosphorous acid and ascorbic acid to make carbon coated LiFePO₄ particles (J. of Power Sources, 159 (2006) 307-311). A co-precipitation method has also been used with nitrates, (NH₄)₂HPO₄, ascorbic acid and ammonia (J. of Power Sources, 146 (2005) 539-543). Finally, a hydrothermal route has also been used (J. of Power Sources, 165 (2007) 656-659).

In ceramic processing methods, gel-casting is a well developed method to make ceramic products with a complex shape. This method uses an organic monomer solution to make a slurry with ceramic particles. The slurry is poured into a mold. After the polymerization reaction of the monomer, a gel forms. This 3-dimensional network keeps the ceramic particles in a certain shape for subsequent drying and sintering processes. Polymerization reactions include two major groups: addition (chain-growth) polymerization and condensation (step-growth) polymerization. In condensation polymerization, the chain growth is accompanied by elimination of small molecules such as H₂O or CH₃OH. In the addition polymerization process, the polymer is formed without the elimination of side products. Addition polymerization involves the linking together of reactant molecules which incorporate either a double or a triple bond. These unsaturated monomers are able to link up with other monomers or other reactant molecules to form the repeating chain. In addition, there are many variants and subclasses of polymerization reaction. The main forms of addition polymerization are free radical addition and ionic (cationic and anionic) polymerization. The free radicals and ions initiate the polymerization reactions. Free radicals are very reactive atoms or molecules which have an unpaired electron. Free-radical initiation has been most thoroughly studied and is most widely employed. There are many different types or categories of initiators, which produce free radicals to initiate polymerization reactions. Decomposition of hydrogen peroxide is used extensively to generate free radical initiators (“Principals of Polymerization” George Odian, Fourth Edittion). The most simple reaction is the decomposition of H₂O₂ according to reaction (1)

H₂O₂→2HO. reaction (1)

The activation energy of reaction (1) is high, 220 kJ/mol. Therefore heating is necessary to initiate the reaction. A redox (reduction-oxidation) reaction is extensively used to decrease the activation energy. Metal ions with lower valance are very common reductants. Among them, Fe²⁺ ions are often used as in reaction (2).

H₂O₂+Fe²⁺→HO.+OH⁻¹+Fe³⁺ reaction (2)

In reaction (2), the oxidation of Fe²⁺ produces a hydroxyl and a HO. free radical. The activation energy for reaction (2) is decreased to 40 kJ/mol. Therefore, reaction (2) can be initiated at room temperature without heating.

### BRIEF OVERVIEW OF THE INVENTION

In the liquid process, iron nitrate and iron citrate are cheap and soluble iron salts. In the practical process they show some drawbacks. During the decomposition, iron nitrate produces NO and NO₂, which are strong oxidizers. These oxidizers have a bad effect on the formation of carbon coating on the surface of LiFePO₄ particles. On the other hand, during decomposition in nitrogen atmosphere, citrate produces too much carbon, which results in a poor electrochemical performance. The present invention provides a solid-liquid mixing method to overcome the above drawbacks.

An organic gel with solid powders has been used as disclosed by Chinese patent CN 1564347. The organic gel method for ceramic synthesis is a well known method, especially for gel-casting, tape casting, slip casting processes. Gel-casting uses a few weight percent of a polymer and makes a high solid volume density (larger than 40%). The gel has higher viscosity than a normal slurry. A ball milling process results in a gel with a very even composition distribution.

The present invention uses water as solvent and water soluble organics to make organic gel. A solid iron source such as iron oxides and iron hydroxides can be used. Lithium source can be soluble such as LiOH, and can also be insoluble such as Li₂CO₃. The phosphorous source can be soluble such as phosphorous acid, phosphor oxide, and different ammonium phosphates. The raw materials and a certain amount of water are loaded into a ball milling jar. The amount of water is enough to dissolve the mixture of lithium compounds, phosphorous compounds and the products by the reaction of these compounds. The main purpose of the milling process is to thoroughly crush agglomerates and form a fully dispersed slurry. The gel forming agents can be added after a defined milling time, which can then be followed by a second milling. The milling process can evenly distribute the raw materials in the gel. The low fluidity of the gel structure prevents the mixture from and/or decreases the composition segregation. Gelation reaction may be initiated just after gelation agents are added into the slurry. It can also be initiated by a post heating process. The gel can then be dried. A spraying dry process can also be used to make dried gel particles. A subsequent calcination process generates the LiFePO₄ particles with a carbon coating or carbon network which can be produced by the decomposition of the organic gel materials.

### BRIEF DESCRIPTION OF THE DRAWINGS

FIG. 1 illustrates XRD patterns of the LiFe PO₄. The patterns are the sample 1, sample 2 and sample 4 by a sequence from bottom to top.

FIG. 2 illustrates a SEM picture of the sample 1.

FIG. 3 illustrates a SEM picture of the sample 2.

### DETAILED DESCRIPTION OF THE INVENTION

### Technical Description and Supporting Data

The candidates of metal and phosphor sources include LiOH, Li₂CO₃, Fe₂O₃, Fe₃O₄, Fe(OH)₃, FeOOH, FeC2O₄, P₂O₅, H₃PO₄, NH₄H₂PO₄, (NH₄)₂HPO₄, etc. Iron compounds are solid particles. Lithium compound and phosphorous compound are pre-dissolved to form a water-solution. Organic gel forming components include monomer, initiator and some additives such as dispersant, catalyst, etc. At first, the solid and solution phases can be milled for several hours. This process can be used to crush all agglomerated solid particles to form a fully dispersed slurry. At the second, gel forming agents are added into the slurry. The polymerization reaction can be immediately initiated or initiated during a subsequent heating process. Then the gel mixture can be dried and calcined to form final product. The slurry with monomer can also be dried by a spraying dry process. During calcinations in a reducing atmosphere, the added organics decompose to form a carbon coating or alternatively network to increase electric conductivity of the LiFePO₄ particles.

Acrylamide is a popular monomer for gel casting process of ceramics. It is somewhat toxic, and is only used in a basic condition. Acrylic acid monomer is not toxic and can be used in an acidic condition. Therefore, acrylic acid is used as the monomer for gel reaction. Fe²⁺ ions may be used as iron source for the products, and used as reductant in the redox reaction (see equation 2). Therefore, hydrogen peroxide, H₂O₂, and Fe²⁺ compound can be co-added to initiate the gel reaction without heating.

In the examples, Fe₂O₃, Fe₃O₄, FeOOH, are used as iron source respectively. FeC2O₄ is used as Fe²⁺ additive with Fe₂O₃. Li₂CO₃ and P₂O₅ are used to make the solution of lithium and phosphorous compounds. The processing procedure is as follows:
(1) P₂O₅ is dissolved in water in a glass milling jar.
(2) Li₂CO₃ is added into the above solution. It will react with P₂O₅ solution. Then all reaction products must be dissolved in the solution, otherwise, it would segregate with Li and/or P rich components.
(3) Iron compound and milling balls are added into milling jar. Milling process continues overnight.
(4) Acrylic acid and H₂O₂ are added into slurry. The gelation reaction can start immediately and the polymerization is completed quickly, as indicated by the Fe²⁺ ion consumption.
(5) The slurry is milled again for 3 hours. The slurry becomes more viscous after the second milling process.
(6) The slurry, which has not fully polymerized, is heated on hot plate with magnetic stirring. Some more H₂O₂ droplets are added. The gelation reaction can be gradually initiated at about 70-80° C. The viscosity of slurry can gradually be increased. Finally, the slurry or gel becomes nearly “solidified.”
(7) The gel is dried at 120° C.
(8) The dried mixture can be milled in an agate vial for 30 minutes to obtain a fine powder.
(9) The powders can be calcined at a different temperature in an atmosphere of 5% H₂ with N₂.
(10) The calcined powders can be milled again in an agate vial to get final particle size.

Sample 1. Reaction of LiFePO₄ from Fe₂O₃ (50 nm).

| Raw material | Mole ratio | Amount | |
|---|---|---|---|
| Li₂CO₃ | 1.03 | 6.044 | g |
| Fe₂O₃ | 1.00 | 12.683 | g |
| P₂O₅ | 1.00 | 11.273 | g |
| H₂O | | 30 | ml |
| Acrylic acid | | 4 | ml |
| H₂O₂ | | 2 | ml |

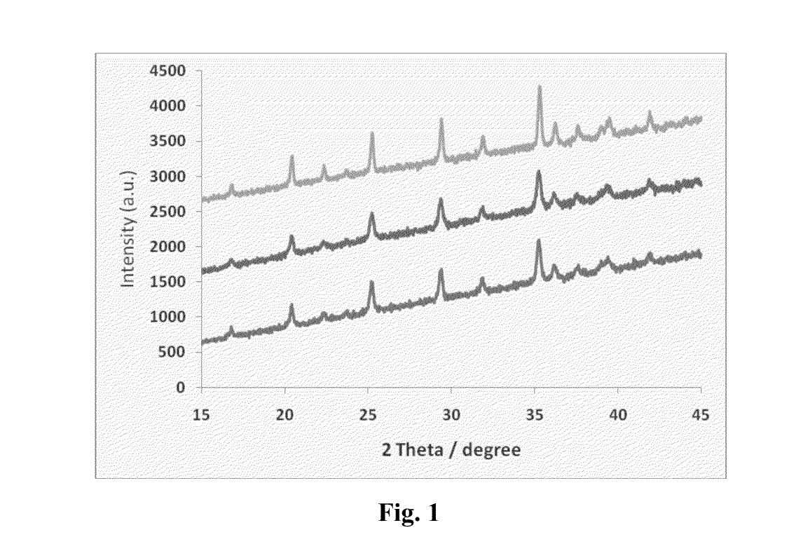

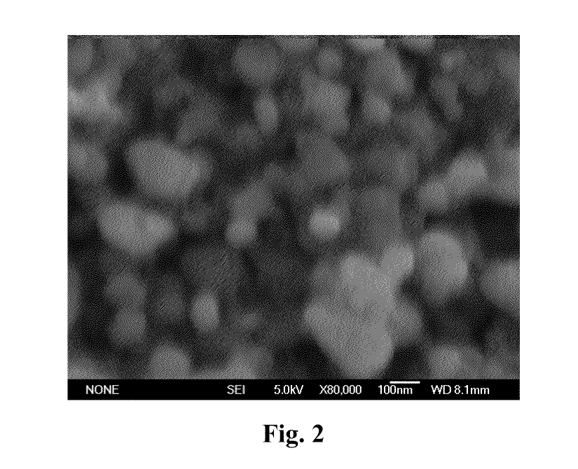

After acrylic acid monomer and H₂O₂ were added into the milled slurry, the slurry became more viscous, but no polymerization occurred. The mixed slurry was heated on a hot plate with stirring. The polymerization reaction occurred at about 70° C. The slurry became more and more viscous. It was finally dried at 120° C. The dried gel was calcined at 650° C. in an atmosphere of 5% H₂ with N₂. As shown in FIG. 1, the XRD of sample 1 reveals a well crystallized olivine type structure. Based on the SEM analysis the particle size is about 100 nm, see FIG. 2.

Sample 2. Reaction of LiFePO₄ from Fe₂O₃ (50 nm) with FeC₂O₄ additive.

| Raw material | Mole ratio | Amount | |
|---|---|---|---|
| Li₂CO₃ | 1.03 | 6.038 | g |
| Fe₂O₃ | 0.98 | 12.416 | g |
| FeC₂O₄ | 0.04 | 0.285 | g |
| P₂O₅ | 1.00 | 11.261 | g |
| H₂O | | 30 | ml |
| Acrylic acid | | 4 | ml |
| H₂O₂ | | 1 | ml |

2% FeC₂O₄ was used to replace Fe₂O₃. After acrylic acid monomer and H₂O₂ were added into the slurry, the polymerization occurred immediately. The milling jar became much warmer. The slurry become very viscous, and lost fluidity. This means FeC₂O₄ prompted the reaction as shown in equation (2).

Sample 3. Reaction of LiFePO₄ from Fe₃O₄ (300 nm).

| Raw material | Mole ratio | Amount | |
|---|---|---|---|
| Li₂CO₃ | 1.03 | 4.089 | g |
| Fe₃O₄ | 1.00 | 8.285 | g |
| P₂O₅ | 1.00 | 7.626 | g |
| H₂O | | 30 | ml |
| Acrylic acid | | 3 | ml |
| H₂O₂ | | 1 | ml |

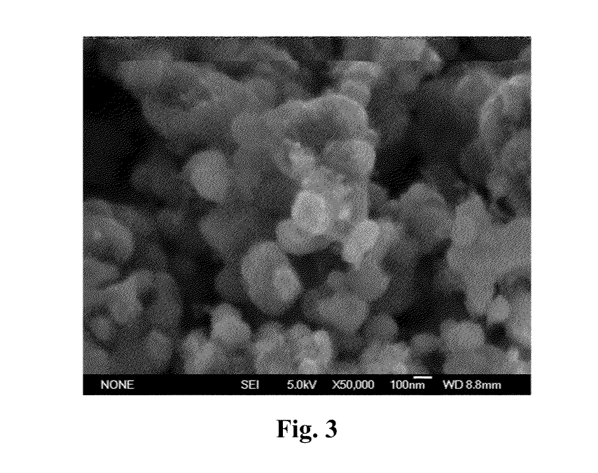

After acrylic acid monomer and H₂O₂ were added into the milling jar, the reaction immediately occurred as in the example 2. This means Fe²⁺ ions in Fe₃O₄ partially dissolved and prompted the reaction as shown in equation (2). As shown in FIG. 1, the XRD of sample 2 reveals a well crystallized olivine type structure. Based on the SEM analysis the particle size is about 100 nm, see FIG. 3.

Sample 4. Reaction of LiFePO₄ from FeOOH (amorphous).

| Raw material | Mole ratio | Amount | |
|---|---|---|---|
| Li₂CO₃ | 1.03 | 5.769 | g |
| FeOOH | 1.00 | 13.471 | g |
| P₂O₅ | 1.00 | 10.760 | g |
| H₂O | | 40 | ml |
| Acrylic acid | | 10 | ml |
| H₂O₂ | | 2 | ml |

FeOOH releases H₂O when it decomposes. H₂O will oxidize the carbon produced from the decomposition of acrylic acid. Therefore, more acrylic acid was used than with the other iron sources. As shown in FIG. 1, the XRD of product reveals a well crystallized olivine type structure.

What is claimed is:

1. A method to generate a LiFePO₄ or an analog of LiFePO₄ comprising: forming a 3-dimension gel structure containing the precursor of the LiFePO₄ or an analog of LiFePO₄ through a polymerization reaction.

2. The method of claim 1, the precursor of LiFePO₄ or its variety includes a solid phase and a liquid phase.

3. The method of claim 2, wherein the solid phase includes compounds of iron and other possible metals, such as Fe₂O₃, Fe₃O₄, FeOOH, FeC₂O₄, etc.

4. The method of claim 2, wherein the liquid phase is a water solution.

5. The method of claim 4, wherein the solvents include lithium compounds, phosphorous compounds and Li—P compounds.

6. The method of claim 1, wherein the polymerization is a reaction of organic monomer, initiator, and other additives.

7. The method of claim 3, wherein the initiator is a peroxide compound.

8. The method of claim 3, wherein the additives includes a reductant such as a Fe²⁺ ion.

9. The method of claim 8, wherein the reductant additive includes one or more other metal compound.

10. The method of claim 4 wherein the solvents include a water soluble metal or non-metal compounds.
